(19) United States
(12) Patent Application Publication
(10) Pub. No.: US 2020/0320165 A1
(43) Pub. Date: Oct. 8, 2020

(54) TECHNIQUES FOR GENERATING TEMPLATES FROM REFERENCE SINGLE PAGE GRAPHIC IMAGES

(71) Applicant: Adobe Inc., San Jose, CA (US)

(72) Inventors: Balaji Vasan Srinivasan, Bangalore (IN); Surya S. Dwivedi, Lucknow (IN); Rohan Kumar, Hazaribag (IN); Pranav Ravindra Maneriker, Columbus, OH (US); Paridhi Maheshwari, Bengaluru (IN); Nitish Bansal, Bathinda (IN)

(21) Appl. No.: 16/376,906

(22) Filed: Apr. 5, 2019

(51) Int. Cl. G06F 17/24; G06F 17/21; G06T 7/11; G06T 11/60

(52) U.S. Cl. CPC G06F 17/248; G06F 17/212; G06T 7/11; G06T 7/90; G06T 2207/20084; G06T 2210/12; G06T 11/60

(57) ABSTRACT

A method includes extracting a set of segments located in a reference single page graphic image. A first segment overlaps with a second segment of the set of segments. The method includes identifying a plurality of bounding areas within the reference single page graphic image. Each segment of the set of segments is associated with a bounding area of the plurality of bounding areas. The plurality of bounding areas includes a first bounding area and a second bounding area, the first bounding area overlapping with the second bounding area. The method includes generating an editable template including a set of editable fields. The set of editable fields is determined based upon the plurality of bounding areas in the reference single page graphic image. A position of an editable field in the editable template is based upon a position in the reference single page graphic image of a corresponding bounding area.

### TECHNICAL FIELD

This disclosure relates generally to facilitating generation of one or more editable templates from one or more reference single page graphic images. More specifically, but not by way of limitation, this disclosure relates to generating the editable templates by segmenting the reference single page graphic images into editable fields using machine learning techniques such as using convolutional neural networks, and, in some cases, generating new single graphic page images using the editable templates and user-provided content, where generating a new single graphic page image includes performing modifications to the editable fields to optimize layout of the one or more editable templates.

### BACKGROUND

Interactive computing environments allow users to perform various computer-implemented functions through graphical interfaces. For instance, an interactive computing environment can provide functionalities such as allowing users to generate custom content displayable on electronic devices, print media, or any other visual medium. Designing the custom content is non-trivial, particularly for novice users of the interactive computing environments or when beginning the design process from a blank environment (e.g., without relying on a template).

Existing tools aimed at assisting the novice user in creating custom content range from simple templates to more complex design systems. However, these tools fail to provide mechanisms to extract design elements from existing reference single page graphic images (e.g., content banners, advertisements, etc.) to create custom editable templates. For example, the simple templates may be based on a limited number of templates designed and packaged as part of a computer software application. Further, the more complex design systems may provide a user with greater freedom in generating custom content, but the blank designs provides a user with little guidance for generating the custom content and fail to leverage successful designs from existing reference single page graphic images. Thus, existing systems are insufficient for generating editable templates that leverage successful designs and layouts of reference single page graphic images.

### SUMMARY

This disclosure relates generally to facilitating generation of one or more editable templates from one or more reference single page graphic images. More specifically, but not by way of limitation, this disclosure relates to generating the editable templates by segmenting the reference single page graphic images into editable fields using a machine learning techniques such as using convolutional neural networks, and, in some cases, generating new single graphic page images using the editable templates and user-provided content, where generating a new single graphic page image includes performing modifications to the editable fields to optimize layout of the one or more editable templates.

In an example, a method includes extracting, by an image editing system, a set of segments located in a reference single page graphic image. In the example, a first segment in the set of segments overlaps with a second segment in the set of segments. Additionally, the method includes identifying, by the image editing system, a plurality of bounding areas within the reference single page graphic image. Each segment of the set of segments is associated with a bounding area of the plurality of bounding areas. The plurality of bounding areas includes a first bounding area and a second bounding area where the first bounding area overlaps with the second bounding area. Further, the method includes generating, based upon the reference single page graphic image, an editable template including a set of editable fields. The set of editable fields are determined based upon the plurality of bounding areas in the reference single page graphic image. For an editable field in the set of editable fields, a position of the editable field in the editable template is based upon a position in the reference single page graphic image of a corresponding bounding area in the plurality of bounding areas.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of an image editing system in which a reference single page graphic image is used to generate an editable template, according to certain embodiments of the present disclosure.

FIG. 2 depicts an example of a process for generating a single page graphic image based upon an editable template and new content using the image editing system of FIG. 1, according to certain embodiments of the present disclosure.

FIG. 3 depicts an example of a template generator subsystem of the image editing system of FIG. 1, according to certain embodiments of the present disclosure.

FIG. 4 depicts a visual representation of a segmentation output of a semantic segmentation subsystem of the template generator subsystem of FIG. 3 and a bounding area output of a bounding area subsystem of the template generator subsystem of FIG. 3, according to certain embodiments of the present disclosure.

FIG. 5 depicts an example of a process for generating an editable template using the template generator subsystem of FIG. 3, according to certain embodiments of the present disclosure.

FIG. 6 depicts a visual representation of a reference single page graphic image, intermediate outputs of the template generator subsystem, and a single page graphic image generated using an editable template and new content provided by a user, according to certain embodiments of the present disclosure.

FIG. 7 depicts an example of a single page graphic image generator subsystem of the image editing system of FIG. 1, according to certain embodiments of the present disclosure.

FIG. 8 depicts an example of a process for generating a layout controlled single page graphic image using the single page graphic image generator subsystem of FIG. 7, according to certain embodiments of the present disclosure.

FIG. 9 depicts an example of an editable template provided to the single page graphic image generator subsystem of FIG. 7 and a layout controlled single page graphic image output from the single page graphic image generator subsystem of FIG. 7, according to certain embodiments of the present disclosure.

FIG. 10 depicts an example of a process for generating a combined editable template from multiple reference single page graphic images, according to certain embodiments of the present disclosure.

FIG. 11 depicts a visual representation of two reference single page graphic images and a combined editable template based on the two reference single page graphic images, according to certain embodiments of the present disclosure.

FIG. 12 depicts an example of a computing system for implementing certain embodiments of the present disclosure.

FIG. 13 depicts an example of a cloud computing system for implementing certain embodiments of the present disclosure.

### DETAILED DESCRIPTION

In the following description, for the purposes of explanation, specific details are set forth to provide a thorough understanding of certain inventive embodiments. However, it will be apparent that various embodiments may be practiced without these specific details. The figures and description are not intended to be restrictive.

This disclosure relates generally to facilitating generation of one or more editable templates from one or more reference single page graphic images. More specifically, but not by way of limitation, this disclosure relates to generating the editable templates by segmenting the reference single page graphic images into editable fields using a machine learning techniques such as using convolutional neural networks, and, in some cases, generating new single graphic page images using the editable templates and user-provided content, where generating a new single graphic page image includes performing modifications to the editable fields to optimize layout of the one or more editable templates.

Techniques are described for generating editable single page graphic templates based on one or more reference single page graphic images. In an example, a reference single page graphic image may be an image of an advertisement, a message banner, or other display format that is presentable to an audience digitally, through print media, or through any other type of visual medium. Generating an editable template based on one or more reference single page graphic images is desirable to leverage a successful design and layout of an existing reference single page graphic image when generating a new single page graphic image with new content provided by a user. For instance, a user is able to provide a particular reference single page graphic image to an image editing system, and the image editing system generates the editable template based on the particular reference single page graphic image that is capable of receiving new content from the user.

The following non-limiting example is provided to introduce certain features. In this example, an image editing system is provided that is capable of receiving one or more reference single page graphic images as input and generating one or more editable templates based upon the input reference images. The image editing system executes one or more algorithms that enable the generation of the editable templates based on the one or more reference single page graphic images. The image editing system accesses or otherwise receives one or more reference single page graphic images from a user.

A reference single page graphic image may contain various types of content. For example, a reference single page graphic image may be an image of a banner, an advertisement, etc. that the user wants to use for creating an editable template. For example, the reference single page graphic image may be an image that the user found particularly successful in expressing content included within the reference single page graphic image, and the user wants to capture the structural design elements of the reference single page graphic image in an editable template that the user can subsequently use for generating new single page graphic images using user-provided content.

Continuing with this example, the image editing system is able to perform pixel-wise segmentation of an input reference single page graphic image into image element classes. As a result of this segmentation, each pixel in the reference single page graphic image is associated with a certain image element class based upon the content displayed by each of the pixels. A pixel can be associated with multiple image element classes. Additionally, the image editing system identifies bounding areas of image elements within the input reference single page graphic image, where the image elements are associated with the image element classes. For instance, one or more of the identified image elements (e.g., a picture, text, a background, etc.) may partially or completely overlap one or more of the other identified image elements. By identifying the bounding areas, the image editing system establishes a boundary of each of the identified image elements and establishes locations where multiple image elements overlap. The image editing system uses the bounding areas of the image elements to generate locations and classes of editable fields in the editable template.

In one or more examples, the image editing system also generates a new single page graphic image using an editable template generated by the image editing system and incorporating new user-provided content. In certain embodiments, the image editing system receives or otherwise accesses an editable template and new content provided by a user to generate a new single page graphic image based on the editable template and incorporating the new content. Because the new content provided by the user can vary (e.g., in length, size) from the content included in the reference single page graphic image from which the editable template was generated, the layout of the editable template generated by the image editing system may not be optimized for the new user-provided content. Accordingly, as part of generating the new single page graphic image, the single page graphic image generator subsystem may use layout optimization functions (e.g., layout energy functions) to change and optimize the layout of the fields in the template to receive the new user-provided content and generate the new single page graphic image using the optimized field locations and the optimized field shapes and sizes.

As described herein, certain embodiments provide improvements to image editing systems by solving problems associated with image editing and image generation. These improvements include more effectively generating editable templates based on reference single page graphic images, where the generated editable templates capture the design elements of the reference single page graphic images. This dramatically simplifies the task of generating templates from reference images—a particularly difficult task that otherwise a user would have to perform manually using some image editor. Generating an editable template from a reference single page graphic image provides a user with a starting point to leverage existing design elements when generating a single page graphic image with new content provided by the user.

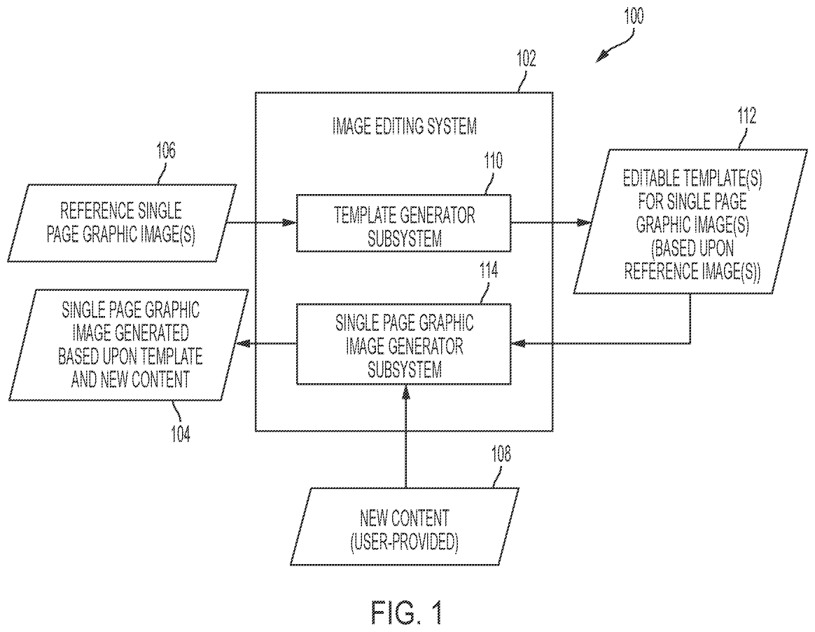

Referring now to the drawings, FIG. 1 is an example of a computing environment 100 in which an image editing system 102 can be used to generate editable templates 112 from one or more reference single page graphic images 106 and then use one or more of the editable templates 112 to generate new single page graphic images 104 that include new content 108 provided by a user of the computing environment 100.

A reference single page graphic image 106 may include an image of an advertisement, of an information banner, or of any other type of image that is displayable digitally, or in print media, or using any other visual medium. In an example, the image editing system 102 may include or be a part of image editing systems such as Adobe Spark, Adobe Photoshop, Adobe Illustrator, or any other image editing system. The reference single page graphic image 106 is selected based on a user-perceived success of communicating a message from the reference single page graphic images 106 to an audience. Repeating this success with user-provided new content 108 may be an objective of the user for generating the editable template 112.

In the embodiment depicted in FIG. 1, the image editing system 102 includes a template generator subsystem 110 and a single page graphic image generator subsystem 114. These subsystems may be implemented using software (e.g., code, instructions, program) executed by one or more processing units (e.g., processors, cores), hardware, or combinations thereof. The software may be stored on a non-transitory storage medium (e.g., on a memory device). The computing environment 100 depicted in FIG. 1 is merely an example and is not intended to unduly limit the scope of claimed embodiments. One of ordinary skill in the art would recognize many possible variations, alternatives, and modifications. For example, in some implementations, the image editing system 102 can be implemented using more or fewer subsystems than those shown in FIG. 1, may combine two or more subsystems, or may have a different configuration or arrangement of subsystems.

The template generator subsystem 110 receives the reference single page graphic images 106 and outputs one or more editable templates 112 based on the reference single page graphic images 106. In one example, the template generator subsystem 110 receives a reference single page graphic image 106 and generates an editable template 112 based upon the received reference single page graphic image 106. In another example, the template generator subsystem 110 receives multiple reference single page graphic images 106 and generates an editable template 112 based upon the multiple reference single page graphic images 106. Processing performed by the template generator subsystem 110 for generating an editable template based upon one or more reference single page graphic images is described below.

As described above, an editable template 112 can be generated based upon a single reference single page graphic image 106 or based upon multiple reference single page graphic images 106. An editable template 112 includes one or more editable fields in which new user-provided content 108 can be inserted to generate a new single page graphic image 104. An editable template 112 captures the design elements of the one or more reference single page graphic images based upon which the template was generated. These design elements may include, for example, the locations and shapes of areas containing text, areas containing images, areas containing shapes, etc. in the reference image or images.

In the embodiment depicted in FIG. 1, the single page graphic image generator subsystem 114 is configured to receive a particular editable template 112 and new content 108 provided by the user and generate a single page graphic image 104 that is based on the particular editable template 112 and that includes the new user-provided content 108. In an example, the single page graphic image 104 is displayable on a digital medium, such as a computer, a tablet, a video screen, etc., or the single page graphic image 104 is also capable of being printed and displayed within a form of print media.

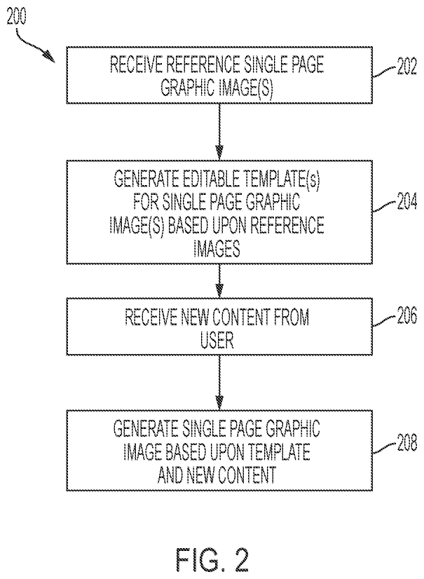

The operations performed by the image editing system 102 are described with reference to FIG. 2, which depicts an example of a process 200 for generating an editable template 112 and generating a single page graphic image 104 based upon the editable template 112 and the new content 108 according to certain embodiments. One or more computing devices (e.g., the computing environment 100) implement operations depicted in FIG. 2 by executing suitable program code. For illustrative purposes, the process 200 is described with reference to certain examples depicted in the figures. Other implementations, however, are possible.

The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in blocks 202 and 204 in FIG. 2 is performed by template generator subsystem 110 depicted in FIG. 1 and the processing depicted in blocks 206 and 208 is performed by the single page graphic image generator subsystem 114 depicted in FIG. 1.

At block 202, the process 200 involves receiving the reference single page graphic images 106 at the image editing system 102. For instance, a user may provide one or more reference single page graphic images 106 to the image editing system 102. For example, a user may identify an image to be used as a reference single page graphic image and image editing system 102 accesses the identified image from a memory location where the image is stored. At block 202, a single reference single page graphic image may be received or multiple reference single page graphic images may be received.

At block 204, the process 200 involves generating an editable template 112 based upon the one or more reference single page graphic images 106 received in block 202. The editable template 112 generated in block 204 includes one or more editable fields in which new user-provided content 108 can be inserted. The size and layout of the editable fields in the editable template 112 is determined based upon processing of the one or more reference single page graphic images 106 by the image editing system 102.

As indicated above, in an example, the template generator subsystem 110 performs the processing 202 and 204 and generates the editable template 112. The template generator subsystem 110 is able to generate an individual editable template 112 based upon a single reference single page graphic image 106 or based upon multiple reference single page graphic images 106. In the case where multiple single page graphic images are used, the editable template 112 that is generated is a combination of design elements extracted from processing the multiple reference single page graphic images 106. In such an example, the template generator subsystem 110 receives instructions from a user indicating individual image elements sourced from multiple reference single page graphic images 106 for inclusion in the editable template 112. Alternatively, the template generator subsystem 110 automatically selects the individual image elements sourced from the multiple reference single page graphic images 106 for inclusion in the editable template 112.

At block 206, the process 200 involves receiving the new content 108 from a user. In certain embodiments, the image editing system 102 provides an interface (e.g., a graphical user interface) that enables a user to provide the new content 108 per block 206.

At block 208, the image editing system 102 generates a new single page graphic image 104, where the generated new single page graphic image is based upon the editable template 112 generated in block 206 and includes the new content 108 received in block 206. In some embodiments, the single page graphic image generator subsystem 114 inserts the new content 108 into the editable fields of the editable template 112 generated in block 204 to generate the single page graphic image 104 at block 208.

In an example, a user provides the single page graphic image generator subsystem 114 with an indication of where to place the new content 108 within the editable template 112. In another example, the single page graphic image generator subsystem 114 determines where to place the new content 108 within the editable template 112 based on the type of content (e.g., text, image, shape) and the image elements classes associated with the editable fields of the editable template 112.

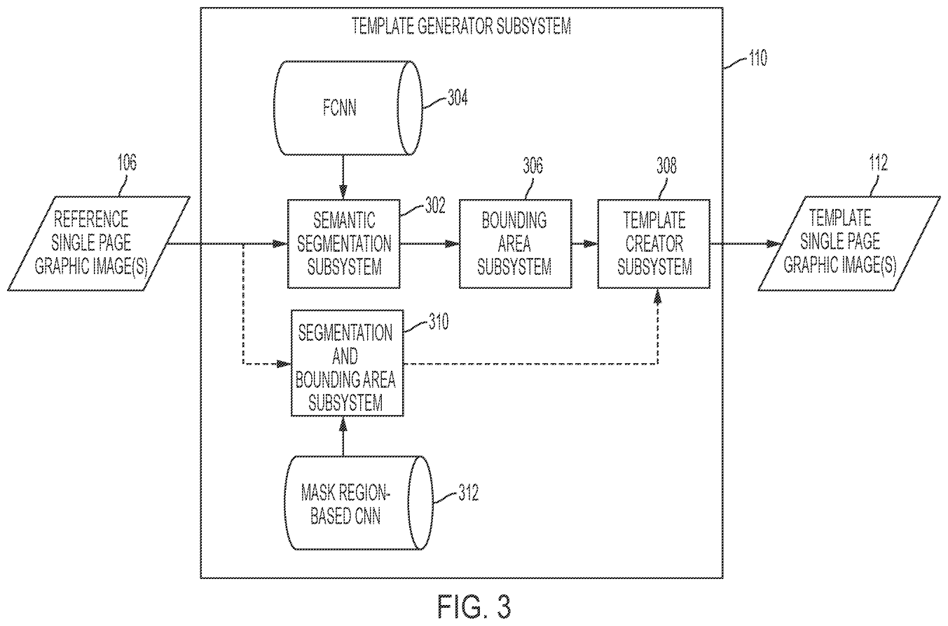

FIG. 3 depicts a high level view of the template generator subsystem 110 of the image editing system 102 according to certain embodiments. In the embodiment depicted in FIG. 3, the template generator subsystem 110 includes a segmentation subsystem 302, a bounding area subsystem 306, and a template creator subsystem 308. In some embodiments, a segmentation and bounding area subsystem 310 replaces the semantic segmentation subsystem 302 and the bounding area subsystem 306. These subsystems may be implemented using software (e.g., code, instructions, program) executed by one or more processing units (e.g., processors, cores), hardware, or combinations thereof. The software may be stored on a non-transitory storage medium (e.g., on a memory device). The template generator subsystem 110 depicted in FIG. 1 is merely an example and is not intended to unduly limit the scope of claimed embodiments. One of ordinary skill in the art would recognize many possible variations, alternatives, and modifications. For example, in some implementations, the template generator subsystem 110 can be implemented using more or fewer subsystems than those shown in FIG. 3, may combine two or more subsystems, or may have a different configuration or arrangement of subsystems.

As discussed above with respect to FIGS. 1 and 2, the template generator subsystem 110 receives the one or more reference single page graphic images 106 from a user. The reference single page graphic images 106 may be any single page graphic images with multiple image elements. In an example, the image elements of the reference single page graphic images 106 include text, images, shapes, background areas, or any other distinguishable image elements within the reference single page graphic images 106.

The reference single page graphic images 106 are provided to a semantic segmentation subsystem 302. The semantic segmentation subsystem 302 applies a fully convolutional neural network (FCNN) 304 to perform a pixel segmentation operation on the reference single page graphic images 106. The semantic segmentation subsystem 302 receives the reference single page graphic images 106 and outputs a pixel-wise segmented image of fixed size with labels indicating an image element class associated with each pixel of the single page graphic images 106. The image element classes include text, image, shape, background, or any other distinguishable image element classes of the image elements in the reference single page graphic image 106. That is, the image element classes identify types of image elements within the reference single page graphic image 106. The FCNN 304 includes layers represented using the following equation:

yᵢⱼ=ƒₖₛ({x_{si+δi,sj+δj}}_{0≤δi,δj≤k}) (1)

where x is an input to a corresponding layer, y is an output of the layer, k is a kernel size, s is a stride/subsampling factor, and ƒₖₛ determines a type of the layer. As used herein, ƒₖₛ represents a matrix multiplication for convolution, an average pooling or a spatial max for max pooling, or an elementwise nonlinear function for activation. The representation of ƒₖₛ is based on a type of layer represented by y, and an end-to-end network is optimized to minimize cross-entropy loss.

To accurately represent image elements of the image element classes identified by the semantic segmentation subsystem 302, the bounding areas for each of the image elements are determined using a bounding area subsystem 306. Because the semantic segmentation subsystem 302 using the FCNN 304 does not directly provide an indication of the bounding areas of the image elements, the bounding area subsystem 306 processes the output of the semantic segmentation subsystem 302 to extract the bounding areas of the image elements. To detect the bounding areas, the bounding area subsystem 306 performs a depth-first search (DFS) around every segmented pixel to identify bounding areas for image elements associated with the segmented pixels. Because the DFS does not limit selection of a pixel in multiple bounding areas, overlapping image elements associated with the multiple bounding areas are identified. In an example, the term overlapping indicates that multiple image elements either partially (e.g., with at least one pixel) or completely overlap one another. During the DFS, bounding areas of an area smaller than a threshold area are rejected to control noise associated with the semantic segmentation subsystem 302. An output of the bounding area subsystem 306 is a set of image elements with an identified image element class associated with respective bounding areas and a location of the bounding areas.

A template creator subsystem 308 receives the image elements, the associated bounding areas, and the location of the bounding areas and outputs the editable template 112. The bounding areas identified by the bounding area subsystem 306 may be displayed in the editable template 112 as editable fields. The editable fields within the editable template 112 are able to receive the new content 108 provided by the user such that the image editing system 102 can generate the final single page graphic image 104 based on the one or more reference single page graphic images 106 and the new content 108.

In an additional example, a segmentation and bounding area subsystem 310 replaces the semantic segmentation subsystem 302 and the bounding area subsystem 306. The segmentation and bounding area subsystem 310 applies a mask region-based convolutional neural network (mask R-CNN) 312 to identify image elements and bounding areas of every pixel of the reference single page graphic images 106. For example, the mask R-CNN 312 implemented by the segmentation and bounding area subsystem 310 extends from a faster region-based convolutional neural network and adds a branch for predicting segmentation masks (i.e., bounding areas) on each region of interest (i.e., each image element) in the reference single page graphic images 106. Further, the mask R-CNN 312 implemented by the segmentation and bounding area subsystem 310 is also able to classify each of the regions of interest as varying image elements.

In an example, the segmentation masks are predicted by the mark R-CNN 312 in a pixel-to-pixel manner. In this manner, the segmentation and bounding area subsystem 310 generates the bounding areas for each identified segment of the reference single page graphic images 106 using the mask R-CNN 312 rather than performing a separate depth-first search after segmentation, as with the FCNN 304. Further, implementing the mask R-CNN 312 decouples mask identification from region classifications. This decoupling results in smoother segmentation masks and, ultimately, smoother bounding areas.

The template creator subsystem 308 receives the segmentation masks and the location of the bounding areas and outputs the editable template 112. Because the bounding areas are identified using the mask R-CNN 312, the bounding area subsystem 306 is bypassed when the segmentation and bounding area subsystem 310 is used. The bounding areas identified by the segmentation and bounding area subsystem 310 may be displayed in the editable template 112 as editable fields. The editable fields within the editable template 112 are able to receive the new content 108 provided by the user such that the image editing system 102 can generate the final single page graphic image 104 based on the one or more reference single page graphic images 106 and the new content 108. While the implementations above describe generating the editable template 112 using the FCNN 304 or the mask R-CNN 312 to generate the editable template 112, other pixel segmentation algorithms are also usable as part of the template generator subsystem 110.

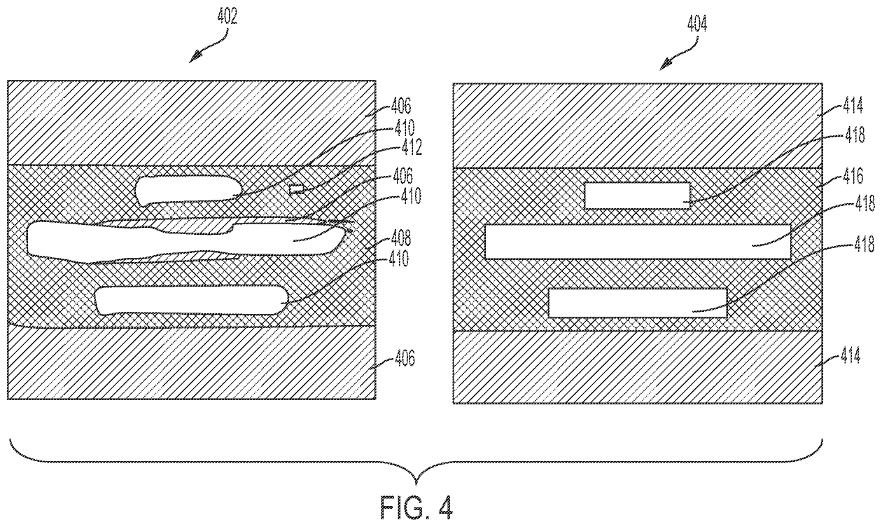

FIG. 4 depicts a visual representation of a segmentation output 402 of the semantic segmentation subsystem 302 of the template generator subsystem 110 and a bounding area output 404 of the bounding area subsystem 306 of the template generator subsystem 110. In one or more examples, the bounding area output 404 is also representative of an output of the segmentation and bounding area subsystem 310. The segmentation output 402 is a visual indication of how each pixel in a reference single page graphic image 106 is labeled to indicate an image element class associated with each of the pixels of the single page graphic images 106.

In an example, areas 406 represent background areas of the reference single page graphic image 106. Continuing with this example, area 408 represents an image area of the reference single page graphic image 106, and areas 410 represent text areas of the reference single page graphic image 106. Further, pixels within the area 412 may also be labeled as text areas. While areas 406-412 are described above as representing specific classes of image elements, each of the areas 406-412 may represent any number of other image element classes that the semantic segmentation subsystem 302 is able to identify. As illustrated, the areas 406-412 generally do not produce boundaries between the other areas 406-412 that are sharp or smooth. Additionally, the layout of the reference single page graphic image 106 includes overlapping elements (e.g., the areas 410 representing the text areas partially or completely overlap the area 408 representing the image area), but each of the pixels are labeled with only a single image element class. Accordingly, further processing is used to process the segmentation output 402 to extract more precise position, size, and other meta details (e.g., type and color of the shape area, font face and size of text, etc.) of the underlying image elements.

A result of the further processing is demonstrated by the bounding area output 404 from the bounding area subsystem 306. As illustrated, the bounding area output 404 includes areas 414 that represent the background area, an area 416 that represents the image area, and areas 418 that represent the text areas. These areas 414-418 all form sharp and smooth transitions between the other areas 414-418. Accordingly, the boundaries of each area 414-418 are accurately defined such that the template generator subsystem 308 is able to generate the editable template 112 with editable fields that correspond to the areas 414-418 with greater accuracy than with only the segmentation output 402.

Further, while identifying the areas 414-418, bounding areas that are less than a threshold size are rejected. For example, the area 412 of the segmentation output 402 has a size that falls below a threshold set by the bounding area subsystem 306. Accordingly, during processing of the segmentation output 402, the bounding area subsystem 306 removes the area 412 such that a bounding area indicating an image element is not created in the bounding area output 404 to correspond with the area 412. In an example, the template creator subsystem 308 uses the bounding area output 404 to generate the editable template 112 based on the areas 414-418 identified in the bounding area output 404.

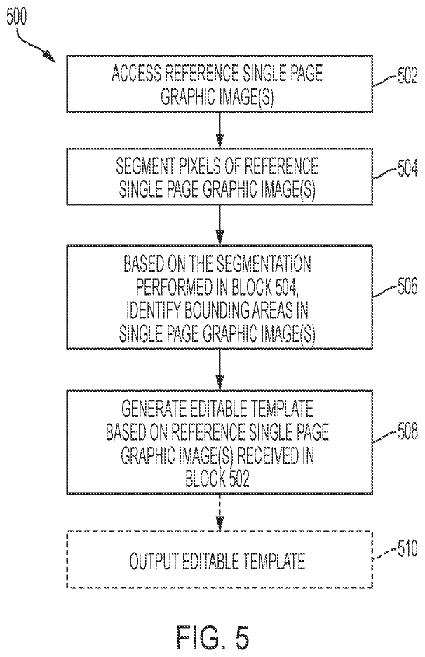

FIG. 5 depicts an example of a process 500 for generating the editable template 112 using the template generator subsystem 110. One or more computing devices (e.g., the computing environment 100) implement operations depicted in FIG. 5 by executing suitable program code. For illustrative purposes, the process 500 is described with reference to certain examples depicted in the figures. Other implementations, however, are possible.

The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 500 presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in blocks 502 to 510 in FIG. 5 is performed by the template generator subsystem 114 depicted in FIG. 3.

At block 502, the process 500 involves accessing one or more of the reference single page graphic images 106. In an example, the reference single page graphic images 106 are provided to the image editing system 102 through a user uploading the reference single page graphic images 106 to the image editing system 102. In such an example, the image editing system 102 directs the reference single page graphic images 106 to the template generator subsystem 110. In another example, the single page reference images 106 are periodically stored in a memory of the image editing system 102, and the image editing system 102 periodically provides batches of the single page reference images 106 to the template generator subsystem 110. Other methods for the template generator subsystem 110 to access the reference single page graphic images 106 are also contemplated.

At block 504, the process 500 involves segmenting the pixels of the reference single page graphic images 106 using the semantic segmentation subsystem 302. The semantic segmentation subsystem 302 applies the fully convolutional neural network (FCNN) 304 to perform the segmentation operation on the reference single page graphic images 106. The FCNN 304 receives the reference single page graphic images 106 and outputs a pixel-wise segmented image of fixed size with labels indicating an image element class associated with each pixel of the single page graphic images 106. The image element classes include text, image, shape, background, or any other distinguishable image element categories of an image element of the reference single page graphic images 106.

At block 506, the process 500 involves identifying bounding areas in the reference single page graphic images 106 based on the segmentation performed in block 504 and using the bounding area subsystem 306. Because the semantic segmentation subsystem 302 using the FCNN 304 does not directly provide an indication of the bounding areas of the image elements, the bounding area subsystem 306 processes the output of the semantic segmentation subsystem 302 to extract the bounding areas of the image elements. To detect the bounding areas, the bounding area subsystem 306 performs a depth-first search (DFS) around every segmented pixel to identify bounding areas for image elements associated with the segmented pixels. The DFS does not limit selection of a pixel in multiple bounding areas. Accordingly, overlapping image elements associated with the multiple bounding areas are identified using the DFS. During the DFS, bounding areas of an area smaller than a threshold area are rejected to control noise associated with the semantic segmentation subsystem 302. An output of the bounding area subsystem 306 is a set of image elements associated with respective bounding areas and a location of the bounding areas.

The following algorithm using pseudo-code outlines a sequence of steps used in the depth first search:

Algorithm 1:

| | |
|---|---|
| 1. | Lₜ = Image Output of Semantic Segmentation |
| 2. | Initialize empty list L |
| 3. | for each pixel N in Lₜ do |
| 4. | if pixel is not visited do |
| 5. | Box=DFS(N) |
| 6. | Append Box with class type in L |
| 7. | end for |
| 8. | |
| 9. | def DFS(N): |
| 10. | for pixel N in Lₜ in Depth First Order do |
| 11. | initialize empty stack S |
| 12. | append N to stack S |
| 13. | While S is not empty do |
| 14. | O = list of four corners initialized with coordinates of N |
| 15. | if N is closer to top left corner of Lₜ than first element of O |
| 16. | Modify first element of O to N |
| 17. | else if N is closer to top right corner of Lₜ than second |
| | element of O |
| 18. | Modify second element of O to N |
| 19. | else if N is closer to bottom right corner of Lₜ than third |
| | element of O |
| 20. | Modify third element of O to N |
| 21. | else if N is closer to bottom left corner of Lₜ than fourth |
| | element of O |
| 22. | Modify fourth element of O to N |
| 23. | end if |
| 24. | for neighboring pixels B of N |
| 25. | if B is of same class as N and B is not visited |
| 26. | Add B to S |
| 27. | end if |
| 28. | return O |
| 29. | return L |

In Algorithm 1, the DFS establishes locations of corners for each of the bounding areas identified during segmentation. Further, the DFS enables identification of image element overlap. For example, the areas 418 (e.g., the text areas) of the bounding area output 404 overlap the area 416 (e.g., the image area), which overlaps the areas 414 (e.g., the background areas). Further, the following Algorithm 2 using pseudo-code provides an example of a simpler form of Algorithm 1 with a region size filter to remove boxes that do not meet a size threshold:

Algorithm 2:

| | |
|---|---|
| 1. | Input I = Image output of semantic segmentation |
| 2. | Initialize L = 0 |
| 3. | while there is an unvisited pixel do |
| 4. | Run DFS from the unvisited pixel N to find a connected |
| | component C |
| 5. | Maintain the 4 points of C closest to the 4 corners of I in Box |
| | while running DFS |
| 6. | L.append(box) |
| 7. | Filter L based on region size |
| 8. | return L |

In an example using the segmentation and bounding area subsystem 310, the boxes 504 and 506 are combined as the mask R-CNN 312 is able to both segment the reference single page graphic images 106 and identify the bounding areas for each identified segment, as discussed above with respect to FIG. 3.

At block 508, the process 500 involves generating the editable template 112 based on the reference single page graphic images 106 using the template creator subsystem 308. The template creator subsystem 308 generates editable fields for the editable template 112. The editable fields correspond to the bounding areas identified at block 506. Further, in one or more examples, more fine-grained details of the reference single page graphic images 106 may also be identified using the template creator subsystem 308. For example, the template creator subsystem 308 may identify type and color of the shape areas, font face and size of text, etc. of the underlying image elements in the bounding areas. Such fine-grained details are available for the template creator subsystem 308 to align the editable template 112 more closely with the layout of the reference single page graphic images 106.

At block 510, the process 500 involves optionally outputting the editable template 112 to an interactive computing environment. In one or more examples, the interactive computing environment provides a user with a mechanism to insert the new content 108 into the editable template 112 to generate the single page graphic image 104 based on the editable template 112 and the new content 108. In other examples, the editable template 112 is not output to an interactive computing environment. Instead, the image editing system 102 receives the new content 108 from the user and automatically assigns the new content to the editable fields of the editable template 112 based on the image element classes (e.g., text, pictures, etc.) provided in the new content 108.

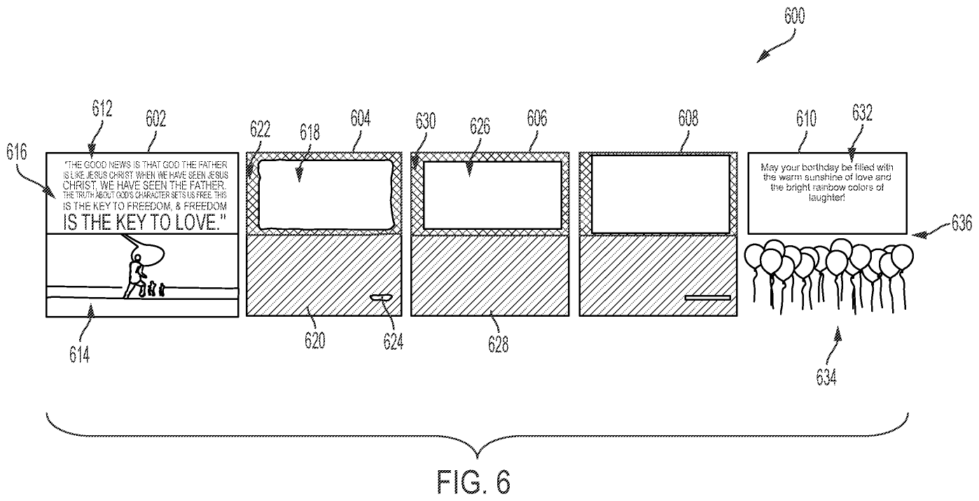

FIG. 6 depicts a visual representation of a reference single page graphic image 602, intermediate outputs 604, 606, and 608 of the template generator subsystem 110, and a single page graphic image 610 generated using the editable template 112 and new content 108 provided by a user. As illustrated, the reference single page graphic image 602 includes a text area 612, an image area 614, and a background area 616. The semantic segmentation subsystem 306 receives the reference single page graphic image 602 and outputs a segmented representation output 604. The segmented representation output 604 includes image element class labels for pixels in a text area 618, an image area 620, and a background area 622. Further, noise indicated in the image area 614 of the reference single page graphic image 602 may be embodied in the segmented representation output 604 as an additional text area 624.

The segmented representation output 604 is provided to the bounding area subsystem 306 to generate a bounding area output 606. The bounding area output 606 is the result of a depth-first search (DFS) performed around every segmented pixel of the segmented representation output 604 to identify bounding areas and layers of the bounding areas (e.g., when more than one bounding area overlaps) for image elements associated with the segmented pixels. Further, the bounding area subsystem 306 may filter out image elements that are smaller than a threshold area. For example, the additional text area 624 is removed from the bounding area output 606 because the small area of the additional text area 624 indicates that the additional text area 624 was generated from noise in the image area 614. Further, the bounding area output 606 includes bounding areas 626, 628, and 630 with clearly defined boundaries that are associated with the text area 618, the image area 620, and the background area 622, respectively. The editable template 112 is generated by generating editable fields within the bounding areas 626, 628, and 630.

A ground truth annotation output 608 represents ground truth segmentation information of the single page graphic image 602. In an example, the single page graphic image 602 is used to train the FCNN 304. In such an example, the ground truth annotation output 608 is known and provides the FCNN 304 with the ground truth annotations of the single page graphic image 602 such that the FCNN 304 is trainable for greater accuracy.

The single page graphic image 610 is generated using the editable template 112 and the new content 108 provided by the user. The single page graphic image 610 includes the new content 108 in the form of text 632, an image 634, and a background 636 inserted in the editable template 112. As illustrated, the font and size of the text area 612 of the reference single page graphic image 602 has not been incorporated into the text 632 of the single page graphic image 610. However, in one or more examples, the template creator subsystem 308 is able to provide a mechanism to recognize and transfer font styles from the reference single page graphic image 602 to the editable template 112 and ultimately the single page graphic image 610.

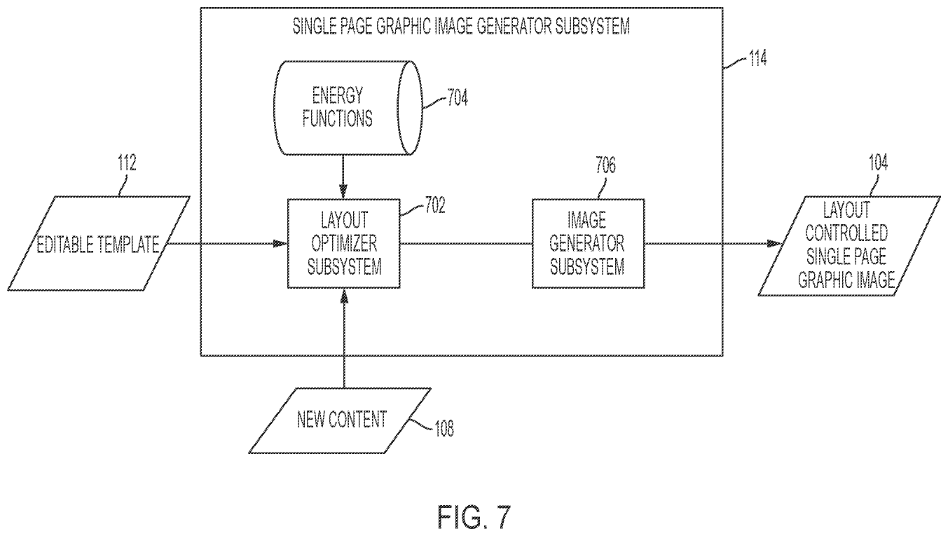

FIG. 7 depicts high level view of the single page graphic image generator subsystem 114 of the image editing system 102. In the embodiment depicted in FIG. 7, the single page graphic image generator subsystem 114 includes a layout optimizer subsystem 702, one or more energy functions 704, and an image generator subsystem 706. These subsystems and functions may be implemented using software (e.g., code, instructions, program) executed by one or more processing units (e.g., processors, cores), hardware, or combinations thereof. The software may be stored on a non-transitory storage medium (e.g., on a memory device). The single page graphic image generator subsystem 114 depicted in FIG. 1 is merely an example and is not intended to unduly limit the scope of claimed embodiments. One of ordinary skill in the art would recognize many possible variations, alternatives, and modifications. For example, in some implementations, the single page graphic image generator subsystem 114 can be implemented using more or fewer subsystems than those shown in FIG. 7, may combine two or more subsystems, or may have a different configuration or arrangement of subsystems.

As depicted, the single page graphic image generator subsystem 114 receives the editable template 112 and the new content 108 provided by the user to generate the single page graphic image 104 that is based on the editable template 112 and the new content 108. In an example, the single page graphic image 104 is displayable on a digital medium, such as a computer, a tablet, a video screen, etc., and the single page graphic image 104 is also capable of being printed and displayed within a form of print media.

In an example, the single page graphic image generator subsystem 114 includes a layout optimizer subsystem 702. While the editable template 112 is able to receive the new content 108 from the user, the new content 108 may change the aesthetics of the resulting single page graphic image 104. For example, less text or varying picture shapes and sizes in the new content 108 may increase whitespace or shift alignment in the single page graphic image 104. Accordingly, the layout optimizer subsystem 702 is implemented to improve a layout of the single page graphic image 104 when the new content 108 is positioned within the editable template 112.

To provide the improved layout, the layout optimizer subsystem 702 relies on an energy based optimization scheme to correct any alignment issues with the single page graphic image 104. For example, the layout optimizer subsystem 702 relies on a set of energy functions 704 associated with varying alignment components. The goal of the layout optimizer subsystem 702 is to minimize a total energy indicated by the energy functions 704 in response to the editable template 112 populated with the new content 108.

An overall energy of a layout in the populated editable template 112 is given by the following equation, which represents a weighted sum of individual energies of varying layout components:

E(X;θ)=ΣᵢwᵢEᵢ(X;αᵢ) (2)

where X is a set of design elements from the populated editable template 112, w is a weight assigned to various energy functions E, α is a learned hyperparameter for an energy function, and θ is a composite of the energy function hyperparameters w and α. In an example, the hyperparameters w and α are learned using a non-linear optimization based on randomized searching from a training corpus of layout designs. During training, the hyperparameters w and a are updated iteratively based on a non-linear inverse optimization framework.

In an example, it is assumed that a set of example layouts X_{T} is optimal for an unknown θ. To estimate θ, an energy difference between the example layouts X_{T} and an optimal layout for an unknown θ is minimized. This minimization process is given by the following equation:

$$G ( θ ) = E ( {X}_{T} ; θ ) - {min}_{X} E ( X ; θ ) \qquad ( 3 )$$

Because the optimization is non-linear, an alternating minimization approach is followed where θ and X_{T} are updated iteratively. At each iteration, the previous θ is used to determine an optimized layout followed by determining a new value of θ that minimizes the value of G(θ). A final value of θ is obtained by repeating the alternating minimization approach over several iterations, and the final value of θ is usable for energy computations in a subsequent layout optimization process.

In one or more examples, a set of the energy functions 704 are used as contributors to Equation 2. For example, the energy functions 704 include, an alignment energy function, a group energy function, a misalignment energy function, a whitespace energy function, a spread energy function, an overlap energy function, or any combination thereof that contribute to the overall energy of the layout of the populated editable template 112. Correct alignment of a layout portrays an organized representation of the image elements in the populated editable template 112. The alignment energy function measures a fraction of element pairs that can be bracketed together under the same alignment type, and the alignment energy function is represented by the following equation:

$${E}_{align}^{a} = - S ( \frac{1}{{n}^{2}} {\sum }_{i ∈ ( all )} ( {\sum }_{j ∈ ( all )} {I}_{ij}^{a} ) ; {α}_{align}^{a} ) \qquad ( 4 )$$

where S(⋅;α) is a sigmoid function that maps the energy function to a value between 0 and 1, n denotes a total number of elements in the populated editable template 112, Iᵢⱼ^{a} represents an indication of whether elements i and j are aligned by the same alignment type a. In an example, alignment types a considered by the energy function of Equation 3 include left alignment, x-center alignment, right alignment, bottom alignment, and y-center alignment. Other alignments are also contemplated.

A group energy encourages aligned element pairs to be clustered together under a common type of alignment. The group energy promotes symmetry in the single page graphic image 104 for visual appeal. A group energy function is represented by the following equation:

$${E}_{g r o u p}^{a} = - S ( \frac{1}{nm} {\sum }_{g} {\sum }_{i ∈ ( a l l )} {I}_{g}^{i} ; {α}_{g r o u p}^{a} ) \qquad ( 5 )$$

where n represents a number of elements, m represents a number of alignment groups, and I_{g}ⁱ represents an indication of whether element i belongs to alignment group g.

Further, minor misalignments between two elements may be visually distracting. To accommodate for misalignments resulting from populating the editable template 112 with the new content 108, a misalignment energy function is provided as part of the overall energy represented in Equation 2. The misalignment energy function is represented by the following equation:

$${E}_{misalign}^{a} = \frac{1}{3 {n}^{2}} {\sum }_{a} {\sum }_{i ∈ ( a l l )} {\sum }_{j ∈ ( a l l )} {I}_{ij}^{a} C ( {d}_{ij}^{a} ) \qquad ( 6 )$$

where dᵢⱼ^{a} is a measure of misalignment including a minimum distance to align elements, and C(⋅) is a cost function. In an example where even minor misalignments are penalized, the cost function C(d) may be represented using the following equation:

$$C ( d ) = 5 arctan ( \frac{d}{0.015} ) \qquad ( 7 )$$

Other equations may also be used to represent the cost function C(d).

Whitespace and spread energy functions also contribute to the overall energy of the layout. In an example, the whitespace energy function encourages whitespace as part of the overall energy by using a negative fraction of a total number of pixels of the editable template 112 that are occupied by the new content 108. The whitespace energy function is represented by the following equation:

$${E}_{whitespace} = - S ( \frac{{\sum }_{p} {I}_{p}}{w h} ; {α}_{w hitespace} ) \qquad ( 8 )$$

where Iₚ is an indicator of whether a pixel p has any of the new content 108, and w and h are the width and height of the editable template 112.

While encouraging whitespace can be visually pleasing to avoid perceived clutter in the editable template 112, too much whitespace can also be visually displeasing. Accordingly, spread is penalized using a spread energy function as a component of the overall energy of Equation 2. The spread energy function is represented by the following equation:

$${E}_{spread} = S ( \frac{1}{{n}^{2}} {\sum }_{i ∈ ( a l l )} {min}_{j ∈ ( all )} {D}_{ij} ; {α}_{spread} ) \qquad ( 9 )$$

where Dᵢⱼ is a Euclidean distance between elements i and j.

An additional component of the overall energy penalizes overlap between elements. An overlap energy function is given by a sum of overlapping pixel areas across all combinations of image elements. The overlap energy function is represented by the following equation:

$${E}_{o ν e r l a p} = S ( \frac{{\sum }_{p} {A}_{p}}{w h} ; {α}_{o ν e r l a p} ) \qquad ( 10 )$$

where Aₚ is an indicator of any overlap at pixel p, and w and h are the width and height of the editable template 112.

Given a set of design elements X of the editable template 112 and the learned hyperparameters θ, the layout optimizer subsystem 702 is tasked with arranging the set of design elements X in a layout with the least total energy, as calculated using Equation 2. In an example, a simulated annealing approach is used by the layout optimizer subsystem 702 to determine the layout with the least total energy. In another example, other optimization algorithms (e.g., hill climbing, gradient descent, etc.) may also be used to determine the layout with the least total energy.

The simulated annealing approach involves starting with an initial layout of the populated editable template 112 and computing the total energy of the initial layout. The approach proceeds to explore various layout proposals and changes the layout of the populated editable template 112 to the proposed layout when the proposed layout reduces the overall energy. This process is repeated over multiple iterations to reach a layout of the populated editable template 112 with optimal energy (i.e., with a lowest calculated overall energy). The following algorithm using pseudo-code provides an example of how the simulated annealing approach provides a layout of the populated editable template 112 with optimal energy:

Algorithm 3:

| | |
|---|---|
| 1. | function SimulatedAnnealing (Layout) |
| 2. | Temperature = 0.01 |
| 3. | T_MIN = 0.005 |
| 4. | coolingRate = 0.1 |
| 5. | previousEnergy = getEnergyOfThisLayout( ) |
| 6. | While T > T_MIN: |
| 7. | i=1 |
| 8. | while i < 100: |
| 9. | new_layout = Call Proposals and adjust the elements ( ) |
| 10. | newEnergy = getEnergyOfThisLayout( ) |
| 11. | If newEnergy < previousEnergy or acceptance_probability > |
| | random( ): |
| 12. | Layout = new_layout |
| 13. | previousEnergy = newEnergy |
| 14. | i = i+1 |
| 15. | T = T*coolingRate |
| 16. | return Layout |

Algorithm 3 calculates the overall energy of layout proposals and accepts changes that reduce the overall energy. Additionally, to avoid being stuck in a local minima, Algorithm 3 provides a mechanism to accept proposals that are not of lower energy with a random probability. To change the layout in Algorithm 3, varying design elements of the populated editable template 112 are changed. For example, a proposed change to alignment involves selecting two design elements and aligning coordinates of the design elements. A proposed change to overlapping design elements involves selecting two design elements, determining whether the design elements have a common area, and separating the design elements if a common area is determined. A proposed change to height and width of a design element involves updating a height, a width, or both of a design element. A proposed change to a position of a single element involves randomly selecting a design element and shifting the position of the design element. A proposed change to the layout also includes randomly swapping the location of two design elements. Other proposed changes to the layout of the populated editable template 112 to reduce the overall energy are also contemplated.

Once the total energy is minimized, the editable template 112 populated with the new content 108 is provided to the image generator subsystem 706. The image generator subsystem 706 generates a layout controlled version of the single page graphic image 104. This layout controlled version of the single page graphic image 104 is capable of being output to the user at an interactive user interface, or the single page graphic image 104 is published to a digital or print medium for distribution to an audience.

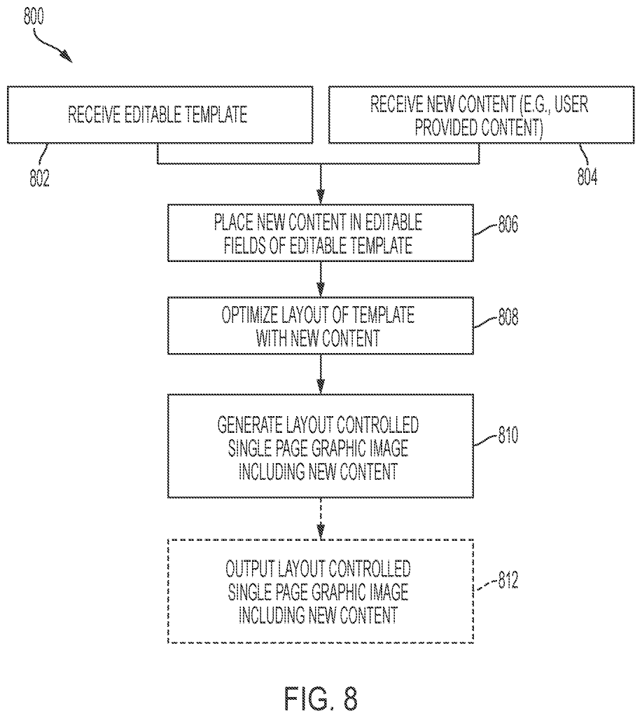

The operations performed by the single page graphic image generator subsystem 114 are described with reference to FIG. 8, which depicts an example of a process 800 for generating the layout controlled single page graphic image 104 using the single page graphic image generator subsystem 114 according to certain embodiments. One or more computing devices (e.g., the computing environment 100) implement operations depicted in FIG. 8 by executing suitable program code. For illustrative purposes, the process 800 is described with reference to certain examples depicted in the figures. Other implementations, however, are possible.

The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 800 presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in blocks 802 to 812 in FIG. 8 is performed by the single page graphic image generator subsystem 114 depicted in FIG. 7.

At block 802, the process 800 involves receiving the editable template 112 at the single page graphic image generator subsystem 114. In an example, the editable template 112 is generated by the template generator subsystem 110 of the image editing system 102 using one or more of the reference single page graphic images 106. In other examples, the editable template 112 may be generated as a unique design that is not based on an existing reference single page graphic image 106.

At block 804, the process 800 involves receiving the new content 108 from the user at the single page graphic image generator subsystem 114. The new content 108 includes text, images, background colors, or any other content that is capable of being placed within editable fields of the editable template 112. In an example, the new content 108 is provided by a user for population in the editable template 112 such that the populated editable template 112 matches a theme of the reference single page graphic image 106 from which the editable template 112 is based.

At block 806, the process 800 involves placing the new content 108 in the editable fields of the editable template 112. In an example, the single page graphic image generator subsystem 114 detects types of content (e.g., text, an image, background information, etc.) represented in the new content 108, and the single page graphic image generator subsystem 114 assigns the detected types of content to similarly labeled editable fields within the editable template 112. In another example, a user interacts with the editable fields of the editable template 112 using an interactive user interface to place the new content 108 within the editable template 112.

At block 808, the process 800 involves optimizing the layout of the editable template 112 that is populated with the new content 108 using the layout optimizer subsystem 702. As mentioned above with respect to FIG. 7, the layout optimizer subsystem 702 uses the energy functions 704 to fine tune the layout of the editable fields in the editable template 112 after the new content 108 is added to the editable fields. The layout optimizer subsystem 702 optimizes a non-linear energy function that encapsulates various aspects of the layout using a simulated annealing process.

At block 810, the process 800 involves generating a layout controlled single page graphic image 104 including the new content 108. The image generator subsystem 706 generates the layout controlled single page graphic image 104. Further, the layout controlled single page graphic image 104 is generated upon completion of the layout optimization process such that the layout controlled single page graphic image 104 has an optimized layout.

At block 812, the process 800 optionally involves outputting the layout controlled single page graphic image 104 including the new content 108 to a display. In an example, the display includes an electronic display of an electronic device. In another example, the display includes a printed medium such as a poster, a handout, a magazine advertisement, etc.

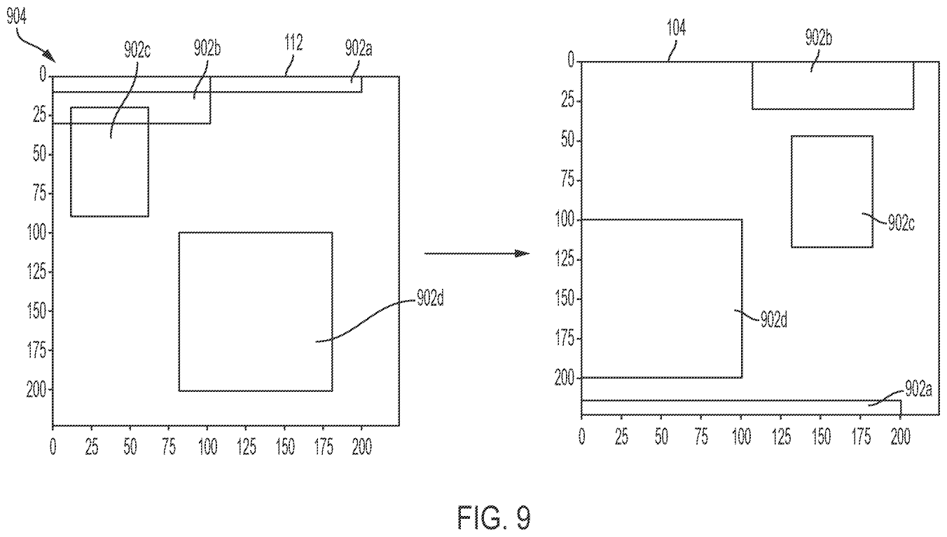

FIG. 9 depicts an example of the editable template 112 provided to the single page graphic image generator subsystem 114 and the layout controlled single page graphic image 104 output from the single page graphic image generator subsystem 114. The editable template 112 includes editable fields 902a, 902b, 902c, and 902d that are generated from image elements of one or more of the reference single page graphic images 106. In an example, the editable fields 902a, 902b, 902c, and 902d are populated with the new content 108 provided by a user. In some examples, population of the editable fields 902a, 902b, 902c, and 902d results in misalignment of the editable fields 902a, 902b, 902c, and 902d due to the size or amount of the new content 108 in comparison to the reference single page graphic image 106. For example, in the illustrated editable template 112, each of the editable fields 902a, 902b, and 902c are clustered in an upper-left corner 904 of the editable template 112. These misalignments lead to an increase in the overall energy measured for the editable template 112.

To resolve the increase in the overall energy, the editable template 112 is provided to the layout optimizer subsystem 702. In an example, a layout of the editable template 112 is first initialized based on a tree-of-parzen-estimator based optimization. The tree-of-parzen estimator provides an estimation for a layout of the editable template 112 that provides a faster convergence than a random layout of the editable template 112. Upon initialization of the layout, the layout optimizer subsystem 702 explores various layout proposals to reduce the overall energy of the editable fields 902a, 902b, 902c, and 902d in the editable template 112. In an example, the layout optimizer subsystem 702 accepts good layout proposals (e.g., layouts that reduce the overall energy) and rejects bad layout proposals (e.g., layouts that increase the overall energy or keep the overall energy the same). The process is repeated over several iterations to reach an optimal overall energy of the editable template 112.

The layout of the editable template 112 with the optimal overall energy is provided to the image generator subsystem 706. At the image generator subsystem 706, a layout controlled version of the single page graphic image 104 is generated. The layout controlled version of the single page graphic image 104 includes the new content 108 within the editable fields 902a, 902b, 902c, and 902d in a new arrangement.

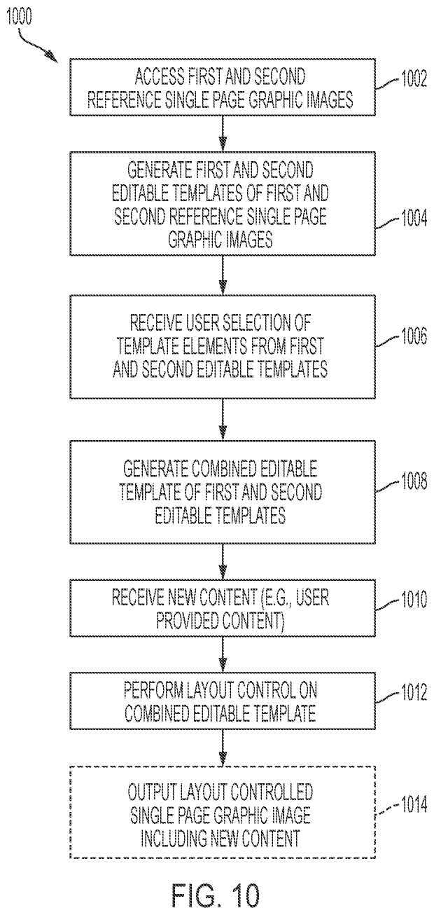

FIG. 10 depicts an example of a process 1000 for generating a combined editable template 112 from multiple reference single page graphic images 106. The image editing system 102 is capable of generating multiple editable templates 112 based on multiple reference single page graphic images 106. In an example, the image editing system 102 is also able to generate the editable templates 112 that combine image elements from multiple reference single page graphic images 106 that are processed by the template generator subsystem 110. One or more computing devices (e.g., the computing environment 100) implement operations depicted in FIG. 10 by executing suitable program code. For illustrative purposes, the process 1000 is described with reference to certain examples depicted in the figures. Other implementations, however, are possible.

The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 1000 presented in FIG. 10 and described below is intended to be illustrative and non-limiting. Although FIG. 10 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in blocks 1002 to 1008 in FIG. 10 is performed by the template generator subsystem 110 depicted in FIG. 1, and the processing depicted in blocks 1010 to 1014 is performed by the single page graphic image generator subsystem 114 depicted in FIG. 7.

At block 1002, the process 1000 involves accessing first and second reference single page graphic images 106 using the image editing system 102. In an example, the reference single page graphic images 106 are provided to the image editing system 102 through a user uploading the reference single page graphic images 106 to the image editing system 102. In such an example, the image editing system 102 directs the reference single page graphic images 106 to the template generator subsystem 110. In another example, the single page reference images 106 are periodically stored in a memory of the image editing system 102, and the image editing system 102 periodically provides batches of the single page reference images 106 to the template generator subsystem 110. Other methods for the template generator subsystem 110 to access the reference single page graphic images 106 are also contemplated.

At block 1004, the process 1000 involves generating first and second editable templates 112 using the first and second reference single page graphic images 106. In an example, the template generator subsystem 110 generates the first and second editable templates 112. The template generator subsystem 110 is able to generate individual editable templates 112 each associated with individual reference single page graphic images 106.

At block 1006, the process 100 involves receiving a user selection of template elements from the first and second editable templates 112. For example, the template generator subsystem 110 receives instructions from a user indicating individual image elements from each of the first and second editable templates 112 for inclusion in a combined editable template 112. In another example, the template generator subsystem 110 randomly selects image elements from each of the first and second editable templates 112 for inclusion in the combined editable template 112.

At block 1008, the process 1000 involves generating the combined editable template 112 using image elements from the first and second editable templates 112. In an example, the template creator subsystem 308 combines the user selected or randomly selected editable fields from the first and second editable templates 112 to generate the combined editable template 112. Further, in one or more examples, additional fine-grained details of the first and second reference single page graphic images 106 may also be identified using the template creator subsystem 308. For example, the template creator subsystem 308 is able to identify type and color of the shape areas, font face and size of text, and other fine-grained details of the underlying image elements in the bounding areas. Such fine-grained details are available for the template creator subsystem 308 to align a look of the image elements the combined editable template 112 more closely with the selected image elements of the first and second reference single page graphic images 106. The combined editable template 112 is optionally output to an interactive display such that a user can interact with the editable fields of the combined editable template 112.

At block 1010, the process 1000 involves receiving the new content 108 from the user for placement within the editable fields of the combined editable template 112. In an example, the single page graphic image generator subsystem 114 detects types of content (e.g., text, an image, background information, etc.) represented in the new content 108, and the single page graphic image generator subsystem 114 assigns the detected types of content to similarly labeled editable fields within the editable template 112. In another example, a user interacts with the editable fields of the editable template 112 using an interactive user interface to place the new content 108 within the editable template 112.

At block 1012, the process 1000 involves optimizing the layout of the combined editable template 112 that is populated with the new content 108 using the layout optimizer subsystem 702. As mentioned above with respect to FIG. 7, the layout optimizer subsystem 702 uses the energy functions 704 to fine tune the layout of the editable fields in the combined editable template 112 after the new content 108 is added to the editable fields. The layout optimizer subsystem 702 optimizes a non-linear energy function that encapsulates various aspects of the layout using a simulated annealing process.

At block 1014, the process 1000 optionally involves outputting the layout controlled single page graphic image 104 to a display. The layout controlled single page graphic image 104 is generated by the image generator subsystem 706 from the combined editable template 112 that includes the new content 108. In an example, the display includes an electronic display of an electronic device. In another example, the display includes a printed medium such as a poster, a handout, a magazine advertisement, etc.

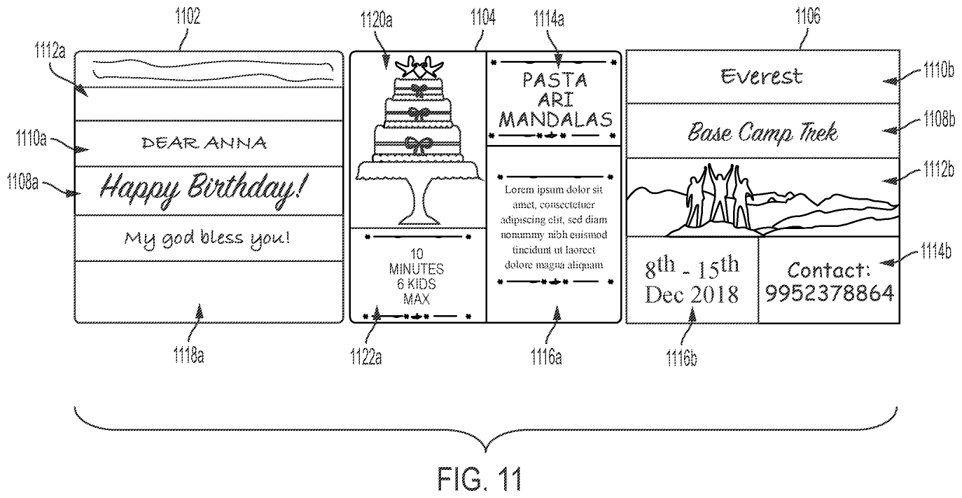

FIG. 11 depicts a visual representation of two reference single page graphic images 1102 and 1104 and a combined single page graphic image 1106 based on the two reference single page graphic images 1102 and 1104. As illustrated, the template generator subsystem 110 of the image editing system 102 identifies image elements 1108a, 1110a, 1112a, 1114a, 1116a, 1118a, 1120a, and 1122a in the two reference single page graphic images 1102 and 1104. Further, using input from a user or using random selection of image elements, the template generator subsystem 110 outputs a combined editable template 112 with the editable fields 1108b, 1110b, 1112b, 1114b, and 1116b that correspond to the image elements 1108a, 1110a, 1112a, 1114a, and 1116a, respectively.

Further, the combined editable template 112 is provided to the single page graphic image generator subsystem 114 to generate the illustrated single page graphic image 1106. In an example, the combined editable template 112 is populated with the new content 108, and the layout optimizer subsystem 702 optimizes the layout using the energy functions 704. After optimization of the layout, the image generator subsystem 706 generates the single page graphic image 1106 that includes the editable fields 1108b, 1110b, 1112b, 1114b, and 1116b in an optimized layout.

Examples of a Computing Environments for Implementing Certain Embodiments

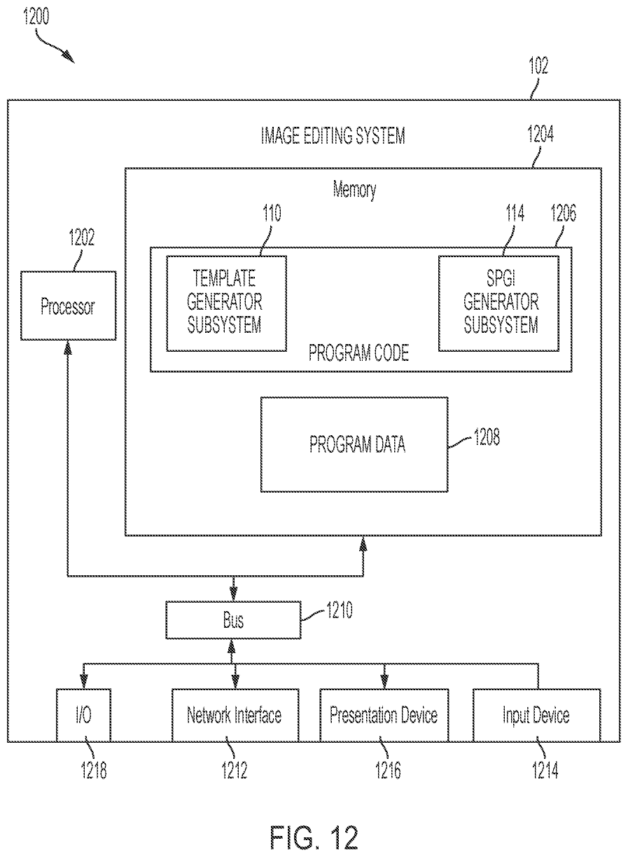

Any suitable computing system or group of computing systems can be used for performing the operations described herein. For example, FIG. 12 depicts an example of an image editing system 102 that makes up at least a portion of a computing system 1200. The implementation of the image editing system 102 could be used for one or more of the template generator subsystem 110 and the single page graphic image generator subsystem 114. In an embodiment, a single image editing system 102 having devices similar to those depicted in FIG. 12 (e.g., a processor, a memory, etc.) combines the one or more operations and data stores depicted as separate subsystems in FIG. 1.

The depicted example of the image editing system 102 includes a processor 1202 communicatively coupled to one or more memory devices 1204. The processor 1202 executes computer-executable program code stored in a memory device 1204, accesses information stored in the memory device 1204, or both. Examples of the processor 1202 include a microprocessor, an application-specific integrated circuit (“ASIC”), a field-programmable gate array (“FPGA”), or any other suitable processing device. The processor 1202 can include any number of processing devices, including a single processing device.

The memory device 1204 includes any suitable non-transitory computer-readable medium for storing program code 1206, program data 1208, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the memory device 1204 can be volatile memory, non-volatile memory, or a combination thereof.

The image editing system 102 executes program code 1206 that configures the processor 1202 to perform one or more of the operations described herein. Examples of the program code 1206 include, in various embodiments, the semantic segmentation subsystem 302, the FCNN 304, the bounding area subsystem 306, the template creator subsystem 308, the segmentation and bounding area subsystem 310, the mask R-CNN 312, the layout optimizer subsystem 702, the energy functions 704, the image generator subsystem 706, or any other suitable systems or subsystems that perform one or more operations described herein (e.g., one or more development systems for configuring an interactive user interface). The program code 1206 may be resident in the memory device 1204 or any suitable computer-readable medium and may be executed by the processor 1202 or any other suitable processor.

The processor 1202 is an integrated circuit device that can execute the program code 1206. The program code 1206 can be for executing an operating system, an application system or subsystem (e.g., the image editing system 102), or both. When executed by the processor 1202, the instructions cause the processor 1202 to perform operations of the program code 1206. When being executed by the processor 1202, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 1204 stores the program data 1208 that includes one or more datasets and models described herein. Examples of these datasets include image data, new image content, image energy data, etc. In some embodiments, one or more of data sets, models, and functions are stored in the same memory device (e.g., one of the memory devices 1204). In additional or alternative embodiments, one or more of the programs, data sets, models, and functions described herein are stored in different memory devices 1204 accessible via a data network. One or more buses 1210 are also included in the image editing system 102. The buses 1210 communicatively couple one or more components of a respective one of the image editing system 102.

In some embodiments, the image editing system 102 also includes a network interface device 1212. The network interface device 1212 includes any device or group of devices suitable for establishing a wired or wireless data connection to one or more data networks. Non-limiting examples of the network interface device 1212 include an Ethernet network adapter, a modem, and/or the like. The image editing system 102 is able to communicate with one or more other computing devices (e.g., a computing device executing a performance evaluation system 102) via a data network using the network interface device 1212.

The image editing system 102 may also include a number of external or internal devices, an input device 1214, a presentation device 1216, or other input or output devices. For example, the image editing system 102 is shown with one or more input/output (“I/O”) interfaces 1218. An I/O interface 1218 can receive input from input devices or provide output to output devices. An input device 1214 can include any device or group of devices suitable for receiving visual, auditory, or other suitable input that controls or affects the operations of the processor 1202. Non-limiting examples of the input device 1214 include a touchscreen, a mouse, a keyboard, a microphone, a separate mobile computing device, etc. A presentation device 1216 can include any device or group of devices suitable for providing visual, auditory, or other suitable sensory output. Non-limiting examples of the presentation device 1216 include a touchscreen, a monitor, a speaker, a separate mobile computing device, etc.

Although FIG. 12 depicts the input device 1214 and the presentation device 1216 as being local to the computing device that executes the performance evaluation system 102, other implementations are possible. For instance, in some embodiments, one or more of the input device 1214 and the presentation device 1216 can include a remote client-computing device that communicates with the image editing system 102 via the network interface device 1212 using one or more data networks described herein.

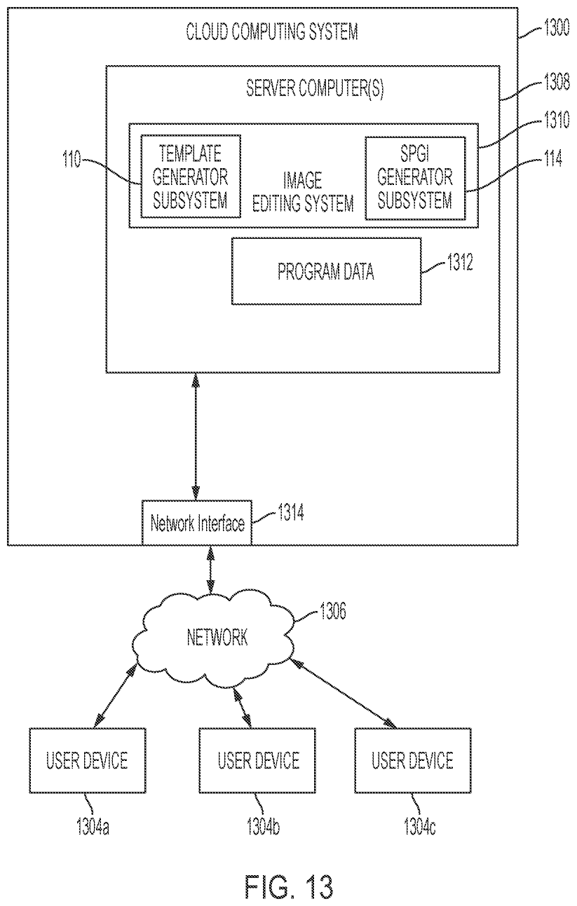

In some embodiments, the functionality provided by the image editing system may be offered as cloud services by a cloud service provider. For example, FIG. 13 depicts an example of a cloud computing system 1300 offering an image editing service that can be used by a number of user subscribers using user devices 1304a, 1304b, and 1304c across a data network 1306. In the example, the image editing service may be offered under a Software as a Service (SaaS) model. One or more users may subscribe to the image editing service, and the cloud computing system performs the processing to provide the image editing service to subscribers. The cloud computing system may include one or more remote server computers 1308.

The remote server computers 1308 include any suitable non-transitory computer-readable medium for storing program code (e.g., an image editing system 1310) and program data 1312, or both, which is used by the cloud computing system 1300 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the server computers 1308 can include volatile memory, non-volatile memory, or a combination thereof.

One or more of the servers 1308 execute the program code 1310 that configures one or more processors of the server computers 1308 to perform one or more of the operations that provide image editing services, including the ability to generate editable templates based upon one or more reference single page graphic images provided by one or more subscribers, and then using the editable templates to generate new single page graphic images that incorporate subscriber-provided new content. As depicted in the embodiment in FIG. 13, the one or more servers providing the services to generate editable templates and/or to generate new single page graphic images based upon the editable templates and new content may implement a template generator subsystem 110 (which includes the semantic segmentation subsystem 302, the FCNN 304, the bounding area subsystem 306, the template creator subsystem 308, the segmentation and bounding area subsystem 310, the mask R-CNN 312, or a combination thereof) and a single page image generator subsystem 114 (which includes the layout optimizer subsystem 702, the energy functions 704, the image generator subsystem 706, or a combination thereof). Any other suitable systems or subsystems that perform one or more operations described herein (e.g., one or more development systems for configuring an interactive user interface) can also be implemented by the cloud computing system 1300.

In certain embodiments, the cloud computing system 1300 may implement the services by executing program code and/or using program data 1312, which may be resident in a memory device of the server computers 1308 or any suitable computer-readable medium and may be executed by the processors of the server computers 1308 or any other suitable processor.

In some embodiments, the program data 1312 includes one or more datasets and models described herein. Examples of these datasets include image data, new image content, image energy data, etc. In some embodiments, one or more of data sets, models, and functions are stored in the same memory device. In additional or alternative embodiments, one or more of the programs, data sets, models, and functions described herein are stored in different memory devices accessible via the data network 1306.

The cloud computing system 1300 also includes a network interface device 1314 that enable communications to and from cloud computing system 1300. In certain embodiments, the network interface device 1314 includes any device or group of devices suitable for establishing a wired or wireless data connection to the data networks 1306. Non-limiting examples of the network interface device 1314 include an Ethernet network adapter, a modem, and/or the like. The image editing service 1302 is able to communicate with the user devices 1304a, 1304b, and 1304c via the data network 1306 using the network interface device 1314.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method in which one or more processing devices perform operations comprising:
extracting, by an image editing system, a set of segments located in a reference single page graphic image, wherein a first segment in the set of segments overlaps with a second segment in the set of segments;
identifying, by the image editing system, a plurality of bounding areas within the reference single page graphic image, wherein each segment of the set of segments is associated with a bounding area of the plurality of bounding areas, and wherein the plurality of bounding areas comprises a first bounding area and a second bounding area, wherein the first bounding area overlaps with the second bounding area; and
generating, based upon the reference single page graphic image, an editable template comprising a set of editable fields, the set of editable fields determined based upon the plurality of bounding areas in the reference single page graphic image, wherein for an editable field in the set of editable fields, a position of the editable field in the editable template is based upon a position in the reference single page graphic image of a corresponding bounding area in the plurality of bounding areas.

2. The method of claim 1, further comprising:
receiving, at the image editing system, new content;
inserting, by the image editing system, the new content within the set of editable fields of the editable template to generate a populated editable template; and
modifying, by the image editing system, a layout of the populated editable template based on changes to the set of editable fields resulting from the new content.

3. The method of claim 2, wherein modifying the layout of the populated editable template comprises:
applying, by the image editing system, at least one energy function to the populated editable template;
performing, by image editing system, an iterative energy reducing transformation to the populated editable template to reduce a measured overall energy of the at least one energy function applied to the populated editable template; and
generating a layout controlled single page graphic image comprising a transformed layout of the populated editable template.

4. The method of claim 3, wherein the at least one energy function is associated with alignment of the set of editable fields, group energy of two or more editable fields of the set of editable fields, misalignment between two or more editable fields of the set of editable fields, whitespace of the populated editable template, spread of the populated editable template, overlap of the set of editable fields, or any combination thereof.

5. The method of claim 1, wherein extracting the set of segments located in the reference single page graphic image comprises classifying each pixel in the reference single page graphic image into one or more classes from a set of classes, wherein at least a first pixel is associated with multiple classes, and wherein the plurality of bounding areas are based upon the set of classes associated with the pixels in the reference single page graphic image.

6. The method of claim 1, further comprising:
accessing, by the image editing system, an additional reference single page graphic image;
extracting, by the image editing system, an additional set of segments located in the additional reference single page graphic image;
identifying, by the image editing system, an additional plurality of bounding areas within the additional reference single page graphic image, wherein each segment of the additional set of segments is associated with an additional bounding area of the additional plurality of bounding areas; and
generating an additional editable template comprising both an additional set of editable fields positioned within the additional plurality of bounding areas within the additional reference single page graphic image and the set of editable fields positioned within the plurality of bounding areas identified in the reference single page graphic image.

7. The method of claim 1, wherein extracting the set of segments located in the reference single page graphic image comprises applying a fully convolutional neural network to the reference single page graphic image, and identifying the plurality of bounding areas comprises performing a depth-first search from each segmented pixel of the reference single page graphic image.

8. The method of claim 1, wherein extracting the set of segments located in the reference single page graphic image and identifying the plurality of bounding areas comprise applying a mask region-based convolutional neural network to the reference single page graphic image.

9. The method of claim 1, wherein the set of segments represent a set of image elements of the reference single page graphic image, and wherein the set of image elements comprise a text element, a shape element, a picture element, or any combination thereof.

10. The method of claim 1, further comprising:
extracting, by the image editing system, meta details of the plurality of bounding areas, wherein the meta details comprise type and color of the plurality of bounding areas and font face and size of text within the plurality of bounding areas.

11. The method of claim 1, wherein extracting the set of segments located in the reference single page graphic image comprises:
performing, by the image editing system, a pixel segmentation operation on the reference single page graphic image to generate labels for each pixel of the reference single page graphic image, wherein the labels indicate an image element class selected from a plurality of image element classes, and wherein the set of segments is determined using the labels for each pixel of the reference single page graphic image.

12. A computing system comprising:
means for extracting, by an image editing system, a set of segments located in a reference single page graphic image, wherein a first segment in the set of segments overlaps with a second segment in the set of segments;
means for identifying, by the image editing system, a plurality of bounding areas within the reference single page graphic image, wherein each segment of the set of segments is associated with a bounding area of the plurality of bounding areas, and wherein the plurality of bounding areas comprises a first bounding area and a second bounding area, wherein the first bounding area overlaps with the second bounding area; and
means for generating, based upon the reference single page graphic image, an editable template comprising a set of editable fields, the set of editable fields determined based upon the plurality of bounding areas in the reference single page graphic image, wherein for an editable field in the set of editable fields, a position of the editable field in the editable template is based upon a position in the reference single page graphic image of a corresponding bounding area in the plurality of bounding areas.

13. The computing system of claim 12, further comprising:
means for accessing, by the image editing system, an additional reference single page graphic image;
means for extracting, by the image editing system, an additional set of segments located in the additional reference single page graphic image;
means for identifying, by the image editing system, an additional plurality of bounding areas within the additional reference single page graphic image, wherein each segment of the additional set of segments is associated with an additional bounding area of the additional plurality of bounding areas; and
means for generating an additional editable template comprising both an additional set of editable fields positioned within the additional plurality of bounding areas within the additional reference single page graphic image and the set of editable fields positioned within the plurality of bounding areas identified in the reference single page graphic image.

14. The computing system of claim 12, wherein the means for extracting the set of segments located in the reference single page graphic image comprises a means for applying a fully convolutional neural network to the reference single page graphic image, and the means for identifying the plurality of bounding areas comprises a means for performing a depth-first search from each segmented pixel of the reference single page graphic image.

15. The computing system of claim 12, further comprising:
means for extracting, by the image editing system, meta details of the plurality of bounding areas, wherein the meta details comprise type and color of the plurality of bounding areas and font face and size of text within the plurality of bounding areas.

16. The computing system of claim 12, wherein extracting the set of segments located in the reference single page graphic image comprises:
means for performing, by the image editing system, a pixel segmentation operation on the reference single page graphic image to generate labels for each pixel of the reference single page graphic image, wherein the labels indicate an image element class selected from a plurality of image element classes, and wherein the set of segments is determined using the labels for each pixel of the reference single page graphic image.

17. A non-transitory computer-readable medium having program code that is stored thereon, the program code executable by one or more processing devices for performing operations comprising:
extracting, by an image editing system, a set of segments located in a reference single page graphic image, wherein a first segment in the set of segments overlaps with a second segment in the set of segments;
identifying, by the image editing system, a plurality of bounding areas within the reference single page graphic image, wherein each segment of the set of segments is associated with a bounding area of the plurality of bounding areas, and wherein the plurality of bounding areas comprises a first bounding area and a second bounding area, wherein the first bounding area overlaps with the second bounding area; and
generating, based upon the reference single page graphic image, an editable template comprising a set of editable fields, the set of editable fields determined based upon the plurality of bounding areas in the reference single page graphic image, wherein for an editable field in the set of editable fields, a position of the editable field in the editable template is based upon a position in the reference single page graphic image of a corresponding bounding area in the plurality of bounding areas.

18. The non-transitory computer-readable medium of claim 17, the program code further executable by the one or more processing devices to perform operations comprising:
receiving, at the image editing system, new content;
inserting, by the image editing system, the new content within the set of editable fields of the editable template to generate a populated editable template; and
modifying, by the image editing system, a layout of the populated editable template based on changes to the set of editable fields resulting from the new content.

19. The non-transitory computer-readable medium of claim 18, wherein modifying the layout of the populated editable template comprises:
applying, by the image editing system, at least one energy function to the populated editable template;
performing, by image editing system, an iterative energy reducing transformation to the populated editable template to reduce a measured overall energy of the at least one energy function applied to the populated editable template; and
generating a layout controlled single page graphic image comprising a transformed layout of the populated editable template.

20. The non-transitory computer-readable medium of claim 19, wherein the at least one energy function is associated with alignment of the set of editable fields, group energy of two or more editable fields of the set of editable fields, misalignment between two or more editable fields of the set of editable fields, whitespace of the populated editable template, spread of the populated editable template, overlap of the set of editable fields, or any combination thereof.
